(19) United States
(12) Patent Application Publication
(10) Pub. No.: US 2026/0237682 A1
(43) Pub. Date: Aug. 13, 2026

(54) CONDUCTIVE FILM AND USE OF THE SAME

(71) Applicant: TOYOTA JIDOSHA KABUSHIKI KAISHA, Toyota-shi (JP)

(72) Inventors: Tomoyuki UEZONO, Okazaki-shi (JP); Keisuke OMORI, Kariya-shi (JP); Hiroyuki YAMAGUCHI, Toyota-shi (JP); Nariaki MIKI, Okazaki-shi (JP)

(73) Assignee: TOYOTA JIDOSHA KABUSHIKI KAISHA, Toyota-shi (JP)

(21) Appl. No.: 19/419,377

(22) Filed: Dec. 15, 2025

(30) Foreign Application Priority Data
Feb. 12, 2025 (JP) 2025-020865

(51) Int. Cl. H01M 4/66; B32B 15/08; B32B 27/20; H01M 4/02

(52) U.S. Cl. CPC H01M 4/666; B32B 15/08; B32B 27/20; H01M 4/661; H01M 4/663; B32B 2250/02; B32B 2264/105; B32B 2264/20; B32B 2307/202; B32B 2457/10; H01M 2004/021

(57) ABSTRACT

A conductive film includes a conductive filler having a spike-shaped form or a structure-shaped form and a resin binder, in which the conductive filler has a ratio of a BET specific surface area to an equivalent sphere surface area based on a D₅₀ of the conductive filler as 5.0 or more and 10 or less, and the conductive filler is contained in an amount of more than 3.0% by mass and less than 20% by mass with respect to a total mass of the resin binder and the conductive filler.

### CROSS-REFERENCE TO RELATED APPLICATION

This application claims priority to Japanese Patent Application No. 2025-020865 filed on Feb. 12, 2025. The disclosure of the above-identified application, including the specification, drawings, and claims, is incorporated by reference herein in its entirety.

### BACKGROUND

### 1. Technical Field

The present specification relates to a conductive film and use of the same.

### 2. Description of Related Art

A conductive adhesive tape using a conductive filler having a spiky shape is known (Japanese Unexamined Patent Application Publication No. 2009-79127 (JP 2009-79127 A)). In the tape, it is disclosed that content of the conductive filler having a spiky shape or a spherical shape or the like is defined, and a particle diameter of the filler and a thickness of an adhesive layer are set to have a predetermined relationship. It is described that the adhesive tape has excellent adhesiveness, conductivity, and level difference absorptivity.

### SUMMARY

In recent years, in a bipolar secondary battery, it has been considered to use a conductive resin layer in which a resin is used as a matrix for a collector or a part thereof. For example, in a case where a conductive film of JP 2009-79127 A is applied to a conductive layer of a bipolar secondary battery, the frequency of occurrence of pinholes may be increased. The pinholes cause various problems also in the secondary battery. In addition, the manufacturing cost for reducing the pinholes is increased. Further, the intended conductivity of the conductive film of JP 2009-79127 A is conductivity in the in-plane direction of a sheet, but in the bipolar secondary battery, low resistance in the thickness direction of the conductive layer is important.

The present specification provides a conductive film having excellent conductivity in the thickness direction of the conductive film and sufficiently reduced frequency of occurrence of pinholes, and use of the same.

According to the present specification, the following means are provided.

[1] A conductive film including:
a conductive filler having a spike-shaped form or a structure-shaped form; and
a resin binder, in which:
the conductive filler has a ratio of 5.0 or more and 10 or less as a ratio of a BET specific surface area to an equivalent sphere surface area based on D₅₀ of the conductive filler; and
the conductive filler is contained in an amount of more than 3.0% by mass and less than 20% by mass with respect to a total mass of the resin binder and the conductive filler.
   [2] The conductive film according to [1], in which the conductive filler has the spike-shaped form.
   [3] The conductive film according to [1] or [2], in which the conductive filler has a ratio of 6.0 or more as the ratio of the BET specific surface area to the equivalent sphere surface area based on D₅₀ of the conductive filler.
   [4] The conductive film according to any one of [1] to [3], in which the conductive filler is contained in an amount of 5.0% by mass or more and 15% by mass or less with respect to the total mass of the resin binder and the conductive filler.
   [5] A collector for a bipolar secondary battery, the collector including a conductive resin layer including
a conductive filler having a spike-shaped form or a structure-shaped form, and
a resin binder, in which
the conductive filler has a ratio of 5.0 or more and 10 or less as a ratio of a BET specific surface area to an equivalent sphere surface area based on D₅₀ of the conductive filler, and the conductive filler is contained in an amount of more than 3.0% by mass and less than 20% by mass with respect to a total mass of the resin binder and the conductive filler.
   [6] The collector according to [5], in which metal foil is laminated on the conductive resin layer.

With the above conductive film, the conductive film contains, in a predetermined range, the conductive filler having a specific particle shape and a specific ratio of the BET specific surface area to the equivalent sphere surface area. As a result, an excellent conductive film having low resistance in a thickness direction and reduced frequency of occurrence of pinholes is provided.

The conductive film is useful as, for example, a conductive resin layer constituting a collector or a part thereof for a bipolar secondary battery or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a conductive filler and a resin binder in a conductive film;

FIG. 2 is a diagram illustrating a bipolar secondary battery;

FIG. 3 is a diagram illustrating an example of a collector;

FIG. 4A is a diagram showing a microscope photograph of Ni powder having a spike-shaped form used in Embodiments;

FIG. 4B is a diagram showing a microscope photograph of Ni powder having a structure-shaped form used in Embodiments;

FIG. 5A is a diagram showing an evaluation cell of a sample in Embodiments; and

FIG. 5B is a diagram showing an evaluation cell of a control example in Embodiments.

### DETAILED DESCRIPTION OF EMBODIMENTS

The present specification relates to a conductive film and use thereof in a bipolar secondary battery or the like. The conductive film disclosed in the present specification can be used as it is for various applications in which conductivity is required, and can be used as a collector or a part thereof of a bipolar secondary battery. The bipolar secondary battery is, for example, a lithium ion secondary battery, and may be a solid battery.

In a case where the secondary battery is a bipolar type, the cell shape is not particularly limited. The bipolar secondary battery is a battery in which a cell in which a bipolar electrode in which a positive electrode active material layer is provided on one surface of a collector and a negative electrode active material layer is provided on the other surface is laminated in series a plurality of times with a separator including an electrolyte interposed therebetween is laminated. The bipolar secondary battery is not particularly limited, but may be used, for example, for vehicle mounting.

In addition, in the present specification, in a case where a numerical value is indicated and “or more” and “or less” are used, the concepts of “or more” and “more than” and the concepts of “or less” and “less than” are included, respectively. In a case where a predetermined numerical value is defined as a critical value, a useful numerical range can be provided even in a case where the numerical value is equal to or more than the numerical value or more than the numerical value. Similarly, a useful numerical range can be provided even in a case where the numerical value is equal to or less than the numerical value or less than the numerical value.

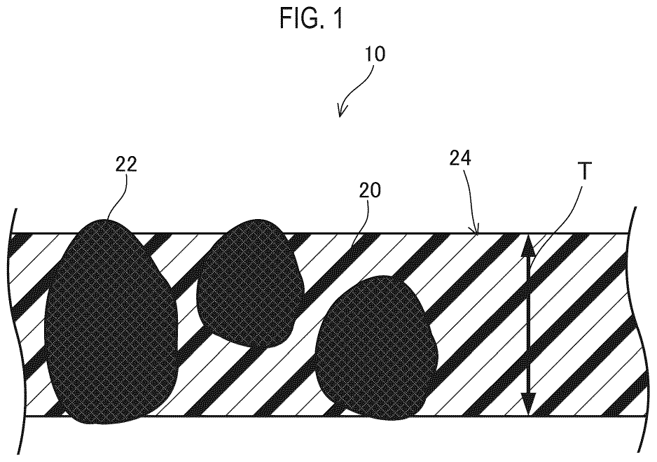

Hereinafter, the conductive film disclosed in the present specification will be described, and then, the use thereof as a collector of a bipolar secondary battery will be described. FIG. 1 shows a cross section of a conductive film 10.

### Conductive Film

As shown in FIG. 1, the conductive film 10 contains a conductive filler 22 and a resin binder 20. The conductive filler 22 is dispersed and held in a resin matrix (hereinafter, simply referred to as a matrix) 24 containing the resin binder 20.

The matrix 24 can appropriately contain other components such as a dispersant, a crosslinking accelerator, and a plasticizer in addition to the resin binder 20. From the viewpoint of electrical stability, the total content of the other components is preferably 0.001% by mass or more and 5% by mass or less, and more preferably 0.001% by mass or more and 3% by mass or less with respect to the total mass of the conductive film 10.

The thickness of the conductive film 10 is not particularly limited, and is appropriately set depending on the application. For example, in a case of a battery application such as a collector, the thickness is, for example, 1 μm or more and 100 μm or less. In addition, for example, the thickness is 3 μm or more, 5 μm or more, 6 μm or more, 7 μm or more, 8 μm or more, 10 μm or more, 15 μm or more, and 20 μm or more. The thickness is, for example, 80 μm or less, 60 μm or less, 40 μm or less, 30 μm or less, 25 μm or less, 20 μm or less, and 15 μm or less. The range of the thickness of the conductive film can be further set by appropriately combining the lower limit and the upper limit within a range of 1 μm or more and 100 μm or less. For example, the range is 8 μm or more and 25 μm or less, 8 μm or more and 20 μm or less, and 8 μm or more and 15 μm or less.

The thickness of the conductive film 10 is a thickness T of the matrix 24 itself including no protrusions based on the conductive filler 22. The thickness T is a value obtained as follows. A cross section cut in the thickness direction of the conductive film 10 is observed using a scanning electron microscope (SEM) with an energy dispersive X-ray spectrometer (EDX). An average value of thicknesses measured at 10 arbitrary points consisting of only the matrix 24 that disperses and holds the conductive filler 22, at which the conductive filler 22 is not observed, is the thickness T.

### Resin Binder

The resin binder 20 is not particularly limited, and various resins can be used. Examples of the resin binder 20 include olefin-based resins such as polyethylene, polypropylene, and polymethylpentene. Examples of the resin binder 20 include acrylic resins such as poly(meth)acrylic acid and poly(meth)acrylic acid methyl. Examples of the resin binder 20 include known thermoplastic resins such as a fluororesin of polytetrafluoroethylene and a halogenated vinyl resin. Examples of the resin binder 20 include thermosetting resins such as an epoxy resin, a vinyl ester resin, an unsaturated polyester resin, a phenol resin, and a melamine resin. Examples of the resin binder 20 include known conductive polymers such as polyaniline, polypyrrole, polythiophene, polyacetylene, polyparaphenylene, polyphenylene vinylene, polyacrylonitrile, and polyoxadiazole. The resins may be used alone or in combination of two or more kinds thereof. The resin that is not conductive is preferably used for providing a conductive path in the thickness direction by the conductive filler, but the present disclosure is not particularly limited thereto. From the viewpoint of electrical stability, the resin is an olefin-based resin such as polyethylene, polypropylene, and polymethylpentene. In addition, an acrylic resin may be preferably used.

### Conductive Filler

Examples of the conductive filler 22 include metal materials or alloy materials such as nickel, aluminum, stainless steel, platinum, gold, silver, copper, and titanium. Examples of the conductive filler 22 include graphite, carbon black (acetylene black, furnace black, and Ketjen black (registered trademark)). Examples of the conductive filler 22 include carbon materials such as carbon nanotubes, carbon nanofibers, carbon nanohorns, diamond-like carbon, and glassy carbon. Examples of the conductive filler 22 include metal compound materials such as metal carbides, metal nitrides, and metal oxides. These may be used alone or in combination of two or more kinds thereof. For example, in the collector 4 of the bipolar secondary battery 100, a metal material such as nickel or a nickel alloy may be effective from the viewpoint of conductivity.

### Particle Form of Conductive Filler

In a case where the conductive filler 22 is a particle form having both the spike-shaped form and the structure-shaped form, the conductive filler 22 has low resistance in the thickness direction and can reduce the occurrence of pinholes. In a case of the sphere-shaped form, the scale-shaped form, or the fiber-shaped form, it is not possible to achieve both low resistance in the thickness direction and the low pinhole occurrence frequency.

The spike-shaped form has a large number of protrusions having a spiky shape on the surface continuously or aggregated. In addition, the particles having a spike-shaped form generally have an irregular shape to a sphere-shaped form as a whole. The particles having a spike-shaped form and containing nickel as a main component can be commercially obtained, for example, as Type 123 of Vale Co., Ltd.

The structure-shaped form refers to a structure in which a plurality of primary particles are fused and connected. Examples of the structure by the connection of the primary particles include a filament-shaped form (chain shape) and a grape-shaped form. The particles having a structure-shaped form (filament-shaped form or the like) and containing nickel as a main component can be commercially obtained, for example, from Vale Co., Ltd.

### Surface Area Characteristics of Conductive Filler

The conductive filler 22 can have a ratio Z which is a ratio of a BET specific surface area (m²/g) to an equivalent sphere surface area (m²/g) based on a D₅₀ as 5.0 or more and 10 or less. The ratio Z indicates how much the actual surface area (BET specific surface area) is increased in a case where the particles of the conductive filler 22 are assumed to be a true sphere.

Here, the equivalent sphere surface area based on the D₅₀ is calculated using the D₅₀ (on a volume basis) obtained in the particle size distribution measurement, assuming that the particles of the conductive filler 22 are true spheres. That is, the weight of one particle is calculated from the specific gravity of the conductive filler 22 assuming that the particles are true spheres, and the number of particles in 1 g of the conductive filler 22 is further calculated. The surface area (m²) per gram is calculated from the number of particles, and is defined as the equivalent sphere surface area (m²/g). The BET specific surface area (m²/g) is calculated based on the BET theory from a gas adsorption isotherm using nitrogen gas. The D₅₀ is a particle diameter at which a proportion of particles having a particle diameter of D₅₀ or less is 50% in a particle size distribution on a volume basis. The D₅₀ can be measured using a laser diffraction/scattering type particle size distribution measuring device.

In a case where the ratio Z is less than 5.0, it is difficult to achieve low resistance, and in a case where the ratio Z exceeds 10, problems such as voids remaining between protrusions on the surface of the conductive filler 22 or protrusions being broken to produce foreign matter are likely to occur. The conductive film 10 exhibited low resistance and a low pinhole occurrence frequency in the thickness direction. It may also be preferable that the ratio Z be, for example, 6.0 or more, 7.0 or more, and 8.0 or more. The ratio Z is, for example, also 9.0 or less, 8.0 or less, 7.0 or less, and 6.5 or less. The range of the ratio Z is, for example, also 6.0 or more and 9.0 or less, 6.0 or more and 8.0 or less, and 6.0 or more and 7.0 or less.

### Content of Conductive Filler

The conductive filler 22 can be contained in an amount of more than 3.0% by mass and less than 20% by mass with respect to the total mass of the resin binder 20 and the conductive filler 22. This is because, in a case where the content is 3.0% by mass or less, it is difficult to obtain a resistance value in the thickness direction. In addition, in a case where the content is 20% by mass or more, for example, in a case of molding the conductive film 10 by extrusion molding (extrusion lamination), the flowability of the film is reduced, which increases the pinhole occurrence frequency. The content of the conductive filler 22 is, for example, also 5% by mass or more, 6% by mass or more, 7% by mass or more, and 8% by mass or more. The content of the conductive filler 22 is, for example, also 15% by mass or less, 14% by mass or less, 13% by mass or less, and 12% by mass or less. The range of the content of the conductive filler 22 is, for example, also 5% by mass or more and 15% by mass or less, 6% by mass or more and 14% by mass or less, and 8% by mass or more and 12% by mass or less. The total mass of the conductive filler 22 and the resin binder 20 with respect to the total mass of the conductive film 10 is not particularly limited, but is 95% by mass or more and 100% by mass or less. The total mass of the conductive filler 22 and the resin binder 20 with respect to the total mass of the conductive film 10 is not particularly limited, but is 97% by mass or more and 100% by mass or less. The total mass of the conductive filler 22 and the resin binder 20 with respect to the total mass of the conductive film 10 is not particularly limited, but is 98% by mass or more and 100% by mass or less. The total mass of the conductive filler 22 and the resin binder 20 with respect to the total mass of the conductive film 10 is not particularly limited, but is 99% by mass or more and 100% by mass or less.

The particle diameter of the conductive filler 22 is not particularly limited, but it may be preferable that the ratio of the particle diameter D₅₀ (μm) to the thickness T (μm) of the matrix 24 be 1.0 times or more and 2.0 times or less. In a case where the ratio is in this range, it is easy to realize low resistance in the thickness direction, and the occurrence of pinholes can be reduced.

### Use of Conductive Film

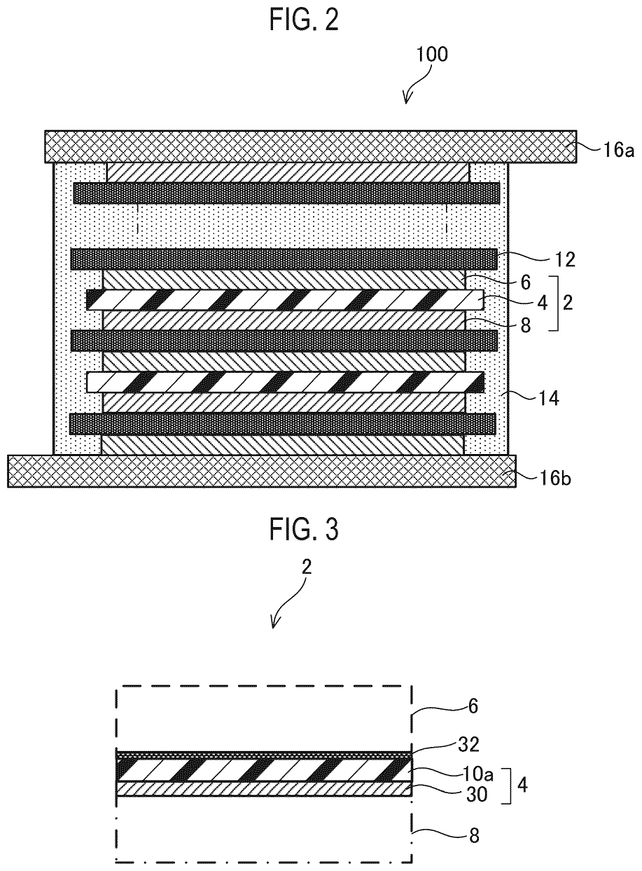

The conductive film 10 itself can be used for applications in which conductivity is expected to be exhibited or for a collector of a bipolar secondary battery. FIG. 2 shows an example of the bipolar secondary battery 100. As shown in FIG. 2, the bipolar electrode 2 is configured by laminating a plurality of times through the separator 12. The negative electrode active material layer 6 and the positive electrode active material layer 8 are fixed to the collector 4 to constitute the bipolar electrode 2. End parts of the secondary battery 100 are provided with end part collectors 16a, 16b that are connected to the outside. In addition, an outer peripheral side of the secondary battery 100 is insulated by an insulating sealing material 14.

The collector 4 can have a conductive resin layer 10a consisting of the conductive film 10. The collector 4 may be composed of only the conductive resin layer 10a. In addition, as shown in FIG. 3, the collector 4 may include the conductive resin layer 10a and a metal layer 30 on at least one surface of the conductive resin layer 10a. In the example shown in FIG. 3, the conductive resin layer 10a is used as a collector layer on the negative electrode side. In this case, the metal layer 30 can be provided on a surface of the conductive resin layer 10a facing the positive electrode active material layer 8. As the metal layer 30, a known metal can be used as a collector on the positive electrode side. The metal layer 30 includes, for example, aluminum, and is typically an aluminum or aluminum alloy foil. Although not shown, in a case where the conductive resin layer 10a is used as a collector layer on the positive electrode side, the metal layer 30 can be provided on a surface of the conductive resin layer 10a facing the negative electrode active material layer 6. In this case, as the metal layer 30, a known metal can be used as a collector on the negative electrode side. The metal layer 30 includes, for example, copper or nickel, and is typically a copper foil or a nickel foil. The thickness of the metal layer 30 as the metal foil is not particularly limited, but is, for example, 5 μm or more and 100 μm or less, and 20 μm or more and 40 μm or less.

The metal layer 30 may be a metal layer 30 obtained by a film forming method such as physical vapor deposition (vacuum vapor deposition, ion plating, sputtering, and the like), chemical vapor deposition, and plating. In a case of the metal layer 30 by physical vapor deposition or the like, the thickness of the metal layer 30 is not particularly limited, but can be, for example, 5 nm or more and 200 nm or less.

The collector 4 may include a carbon coating layer 32 having electron conductivity between the negative electrode active material layer 6 and/or the positive electrode active material layer 8, in addition to the conductive resin layer 10a, as necessary. The carbon coating layer 32 includes a carbon material such as acetylene black, carbon black, and graphite. The carbon coating layer 32 can improve the adhesiveness between the collector 4 and the active material layers 6, 8. The carbon coating layer 32 is provided to be in contact with the active material layers 6, 8. In a case where the collector 4 includes the metal layer 30, the carbon coating layer 32 is provided on a surface of the metal layer 30 facing the active material layers 6, 8. In the carbon coating layer 32, the carbon material is a main component, and the resin such as the resin binder described above binds the carbon materials to each other. The thickness of the carbon coating layer 32 is, for example, 0.1 μm or more and 5 μm or less.

### Method for Manufacturing Collector

A method of manufacturing the collector 4 including the conductive resin layer 10a disclosed in the present specification includes preparing a conductive resin composition containing the conductive filler 22 and the resin binder 20. The method of manufacturing the collector 4 includes molding the conductive resin layer 10a which is the conductive film 10 using the conductive resin composition.

With the method, the collector 4 for a bipolar secondary battery in which the resistance in the thickness direction of the conductive resin layer 10a and the collector 4 is maintained low can be obtained. Various aspects of the conductive film 10 can be appropriately applied to the resin binder 20, the conductive filler 22, the ratio Z, the matrix 24 and the thickness T, the particle diameter D₅₀, and the like in the conductive resin layer 10a.

The conductive resin composition can be prepared by mixing the conductive filler 22 and the resin binder 20 (or a raw material thereof), and additives such as a dispersant and a solvent as necessary, using a known mixer.

In the conductive resin layer 10a, the matrix 24 is provided in a film-like shape intended to have a predetermined thickness T. In manufacturing the conductive resin layer 10a, a person skilled in the art can adjust the thickness of the matrix 24 of the conductive resin layer 10a to be the intended thickness T by a suitable number of experiments, calculations, or the like in accordance with the composition of the conductive resin layer 10a.

The molding method is not particularly limited, and a known film forming method for manufacturing the conductive film 10 can be used. From the viewpoint of efficiently manufacturing the conductive resin layer 10a, for example, a molding method such as a casting method with coating, or an extrusion molding method can be adopted.

In a case of adopting the extrusion molding method, the conductive filler 22 is subjected to a thermal load. Therefore, it is preferable to use a metal material such as a metal or an alloy, or a carbon material as the conductive filler 22. In addition, in order to cause the conductive filler 22 to penetrate in the thickness direction against a shearing force during extrusion, a spike-shaped form and a structure-shaped form are suitable. From the viewpoint of securing low resistance in the thickness direction and reducing pinholes, the spike-shaped form may be more suitable.

In a case where the collector 4 is composed of the conductive resin layer 10a alone, for manufacturing the collector 4, the collector 4 can be obtained as it is by obtaining the conductive resin layer 10a. In a case where the collector 4 is composed of the conductive resin layer 10a and the metal layer 30, an extrusion lamination method of laminating the conductive resin layer 10a on the metal foil that is the metal layer 30 at the same time as the extrusion molding can be adopted to manufacture the collector 4. With the method, the collector 4 including the conductive resin layer 10a and the metal layer 30 can be efficiently obtained.

In a case where the collector 4 includes the carbon coating layer 32, a composition containing a carbon material, a resin binder, and a dispersion medium such as NMP as necessary can be applied to the metal layer 30 and/or the conductive resin layer 10a and appropriately dried. In this manner, a composition containing a dispersion medium such as NMP as necessary can be imparted to the metal layer 30 and/or the conductive resin layer 10a.

In the above, the method of manufacturing the collector 4 has been described, but the conductive resin layer 10a included in the collector 4 is an example of the conductive film 10. According to the present specification, the method of manufacturing the conductive film 10 may include preparing a conductive resin composition containing the conductive filler 22 and the resin binder 20, and molding the conductive film 10 using the conductive resin composition.

### Secondary Battery and Manufacturing Method of The Same

The secondary battery disclosed in the present specification is a bipolar secondary battery 100, and can includes a bipolar electrode 2 including the collector 4 including the conductive resin layer 10a disclosed in the present specification. With the secondary battery 100, the resistance in the thickness direction is maintained low by using the collector 4 including the conductive resin layer 10a, and the frequency of occurrence of pinholes is reduced. Therefore, a secondary battery 100 advantageous from the viewpoint of cost and battery characteristics is provided. According to the present specification, the bipolar electrode 2 including the collector 4 is also provided.

The secondary battery 100 includes the bipolar electrode 2 in which the negative electrode active material layer 6 is provided on one surface of the collector 4 and the positive electrode active material layer 8 is provided on the other surface. Further, the secondary battery 100 can include the carbon coating layer 32 on one surface and/or the other surface of the collector 4 in a predetermined laminating form, as necessary. In addition, the secondary battery 100 has a structure in which a plurality of the bipolar electrodes 2 are laminated in series through the separator 12.

The secondary battery 100 of this type can be manufactured by a person skilled in the art based on an appropriate known method. The negative electrode active material layer 6 and the positive electrode active material layer 8 are not particularly limited in terms of the separator 12, the sealing material 14, and end part collectors 16a, 16b, and known materials can be used for these.

Hereinafter, Embodiments will be described to more specifically describe the disclosure of the present specification. Therefore, Embodiments below are for describing the disclosure of the present specification and are not intended to limit the scope thereof.

### Embodiment 1

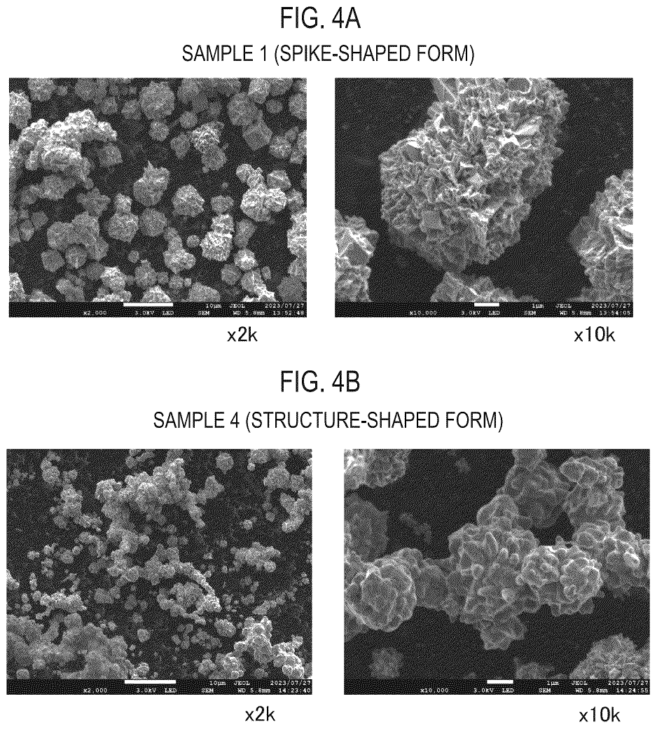

In the present embodiment, various conductive resin compositions were prepared, and a collector in which the obtained conductive resin layer was integrated with an Al foil was produced (samples 1 to 5 and comparative example samples 1 to 5). For these collectors, a resistance value in the thickness direction was evaluated. As the conductive filler in each of the conductive resin compositions, Ni powder having the form and the particle size distribution shown in Table 1 was used. In addition, as the resin binder, adhesive polypropylene (for extrusion lamination) was used. The resin binder and the conductive filler were put into a twin-screw extruder at a mass ratio of 90:10. The mixture was kneaded at 240° C. to obtain a conductive resin composition. Further, the conductive resin composition was heated to 280° C. with an extrusion lamination device and directly laminated on an Al foil (40 μm thick). For reference, FIGS. 4A and 4B show microscope photographs of the Ni powder having a spike-shaped form of the sample 1 and the Ni powder having a structure-shaped form of the sample 4.

The crushed material 1 (0.30 MPa) was prepared by crushing one kind of Ni powder using a crusher at that pressure.

Regarding the D₅₀, the D₅₀ was obtained by measuring the particle size distribution (on a volume basis) using a laser diffraction/scattering type particle size distribution measuring device. The equivalent sphere surface area (m²/g) is calculated as follows. Using this D₅₀, the weight of one particle is calculated from the specific gravity of the conductive filler 22 assuming that the particles of the used conductive filler are true spheres. Further, the number of conductive fillers in 1 g was calculated, and the surface area (m²) per gram was calculated from the number of conductive fillers, and was defined as the equivalent sphere surface area (m²/g). The BET specific surface area (m²/g) was calculated based on the BET theory from a gas adsorption isotherm using nitrogen gas.

The resistance value (mΩ) was measured by sandwiching the collector from both sides in the thickness direction with an electrode having a diameter of 20 mm, and the volume resistivity was calculated by multiplying the electrode area and dividing by the film thickness. The thickness T of the matrix of the conductive resin layer was an average value of thicknesses measured at 10 arbitrary points at which the Ni powder was not observed by observing a lamination cross section cut in the thickness direction of the conductive resin layer using a SEM with EDX. The measurement results are shown together with Table 1. In addition, the appearance of each of the various collectors was observed to evaluate the frequency of occurrence of pinholes (A: excellent, B: good, C: normal, D: defective). The results are shown together with Table 1 (NT: not tested).

TABLE 1

| | | | Filler | | | BET Specific | | | IV |
|---|---|---|---|---|---|---|---|---|---|
| | | | Content | | Thickness | Surface Area/ | Volume | Pinhole | Resistance |
| | | | % by | D₅₀ | T | Equivalent Sphere | Resistivity | Occurrence | Ratio |
| Category of Sample | | Filler Form | mass | μm | μm | Surface Area | Ω · cm | Frequency | % |
| Sample | 1 | Spiky Shape | 5.0 | 10.1 | 10 | 6.28 | 190 | B | 103 |
| | 2 | Spiky Shape | 10 | 10.1 | 10 | 6.28 | 160 | B | 98 |
| | 3 | Spiky Shape | 15 | 10.1 | 10 | 6.28 | 121 | B | 96 |
| | 4 | Structural Shape | 10 | 18.3 | 10 | 5.70 | 91 | C | 101 |
| | 5 | Structural Shape | 10 | 18.8 | 13 | 5.03 | 133 | C | 102 |
| Comparative | 1 | Spiky Shape | 3.0 | 10.1 | 10 | 6.28 | 5163 | B | 153 |
| Example | 2 | Spiky Shape | 20 | 10.1 | 10 | 6.28 | 84 | D | NT |
| Sample | 3 | Structural Shape | 10 | 5.6 | 9.0 | 3.33 | 4273 | B | 216 |
| | 4 | Scale Shape | 10 | 10.3 | 10 | 4.74 | 2840 | C | 115 |
| | 5 | Crushed Material 1 | 10 | 4.8 | 10 | 3.62 | 3164 | A | 423 |
| | | (0.30 MPa) | | | | | | | |

With the samples 1 to 5 and the comparative example samples 1 to 5 of Table 1, the following was found. In a case where the filler form is the spike-shaped form and the structure-shaped form and the BET specific surface area/Equivalent sphere surface area is 5.0 or more, the volume resistivity in the thickness direction is excellent, and the pinhole occurrence frequency is low. In addition, with the samples 1 to 5, the following was found. The filler form being the spike-shaped form and the structure-shaped form and the BET specific surface area/Equivalent sphere surface area being 6.0 or more will further contribute to the low resistance in the thickness direction and the low pinhole occurrence frequency. Among these, it was found that, in a case of the spike-shaped form, the pinhole occurrence frequency is further reduced.

In a case where the BET specific surface area/Equivalent sphere surface area exceeds 10, voids between protrusions of the filler or damage to particles generally occur, which causes unintended problems. From this, it was considered that, in a case where the BET specific surface area/Equivalent sphere surface area is 10 or less, the low resistance and the low pinhole occurrence frequency can be maintained.

In addition, according to the comparative example sample 1, it was found that, in a case where the filler content was 3.0% by mass, the low resistance in the thickness direction could not be maintained. According to the comparative example sample 2, it was found that, in a case where the filler content was 20% by mass, the low resistance in the thickness direction could be maintained, but the pinhole occurrence frequency increased. It was found that the samples 1 to 3, each having a filler content of 5.0% by mass, 10% by mass, and 15% by mass, respectively, contributed to the low resistance and the low pinhole occurrence frequency in the thickness direction. From the above, it was found that the filler content being more than 3.0% by mass and less than 20% by mass, and more preferably 5% by mass or more and 15% by mass or less, contributes to the low resistance and the low pinhole occurrence frequency in the thickness direction.

In addition, it was found that the ratio of the D₅₀ to the thickness T of the matrix in a range of 1.0 or more and 2.0 or less contributes to the low resistance in the thickness direction.

### Embodiment 2

In the present Example, a monopolar structure coin cell was produced using the collector (samples 1 to 5 and comparative example samples 1, 3 to 5) prepared in Embodiment 1, and the IV resistance was measured. A ratio of the IV resistance of the bonding foil (collector for a bipolar type in the related art) as a control example is also shown in Table 1.

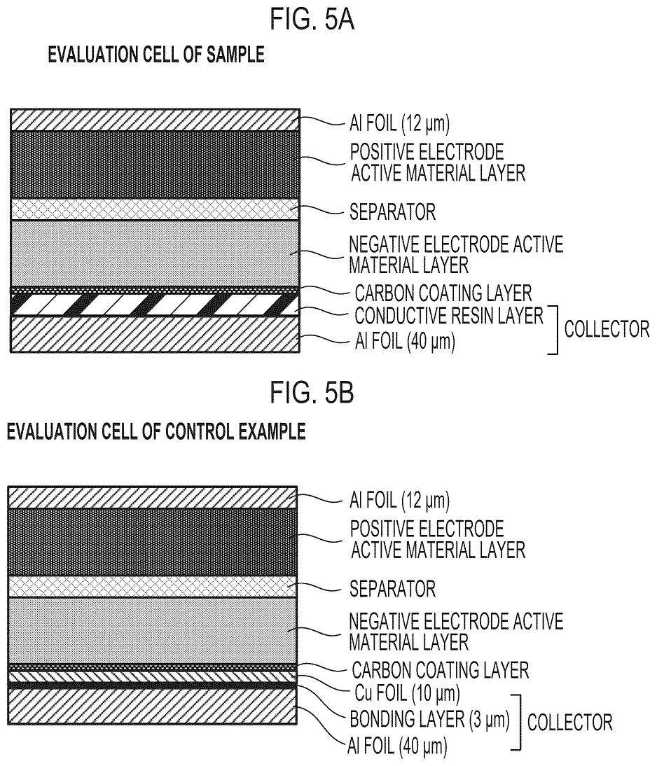

The structure of the evaluation cell of the sample and the control example is shown in FIGS. 5A and 5B. A carbon coating layer, a negative electrode active material layer, and a positive electrode active material layer were sequentially provided on the collector with an Al foil prepared in Embodiment 1, and integrated with a separator layer to prepare an evaluation cell. The preparation and formation of each of the layers are shown below.

### Carbon Coating Layer

Acetylene black and PVDF (mass ratio of 90:10) were prepared as a coating liquid having a solid content of 30% with N-methylpyrrolidone (NMP), and applied onto the conductive resin layer side of the collector at a mass of 1 mg/cm² using an applicator and dried.

### Negative Electrode Active Material Layer

Amorphous-coated graphite as an active material, carboxymethyl cellulose (CMC) as a thickener, and styrene butadiene rubber (SBR) as a binder were mixed at a mass ratio of 97:0.7:2.3 to prepare a negative electrode paste. The prepared negative electrode paste was applied onto the carbon coating layer at a mass of 22.6 mg/cm² using an applicator, dried, and roll-pressed to form a negative electrode layer having a predetermined negative electrode density (1.2 g/cm²).

### Positive Electrode Active Material Layer

As an active material, nickel cobalt manganese lithium (NCM), acetylene black as a conductive auxiliary agent, and PVDF, carboxymethyl cellulose (CMC), and styrene butadiene rubber (SBR) as a binder were mixed at a mass ratio of 95:2.5:2.5 to prepare a positive electrode paste. The Al foil (12 μm thick) application of the prepared positive electrode paste was performed onto the carbon coating layer at a mass of 38 mg/cm² using an applicator, dried, and roll-pressed to provide a positive electrode layer having a predetermined positive electrode density (3.0 g/cm²).

In the control example, a Cu foil (10 μm) was integrated with an Al foil (40 μm thick) through a bonding layer (3 μm), and the carbon coating layer was provided on the surface of the Cu foil, except for this, the preparation was performed in the same manner as described above.

As shown in Table 1, in the cells using the collectors of the samples 1 to 5, the IV resistance ratio was the same as in a case where the bonding foil was used. On the other hand, in the cells using the collectors of the comparative example samples 1, 3 to 5, the IV resistance ratio was significantly deteriorated. It is considered that this is due to an increase in resistance and/or an increase in the pinhole occurrence frequency in the thickness direction.

The conductive filler having a spike-shaped form and a structure-shaped form and a BET specific surface area/Equivalent sphere surface area of 5.0 or more and 10 or less is used in an amount of more than 3.0% by mass and less than 20% by mass. As a result, it was found that the low resistance in the thickness direction and the low pinhole occurrence frequency can be realized, and thus an excellent collector can be obtained.

What is claimed is:

1. A conductive film comprising:
a conductive filler having a spike-shaped form or a structure-shaped form; and
a resin binder, wherein:
the conductive filler has a ratio of 5.0 or more and 10 or less as a ratio of a BET specific surface area to an equivalent sphere surface area based on D₅₀ of the conductive filler; and
the conductive filler is contained in an amount of more than 3.0% by mass and less than 20% by mass with respect to a total mass of the resin binder and the conductive filler.

2. The conductive film according to claim 1, wherein the conductive filler has the spike-shaped form.

3. The conductive film according to claim 2, wherein the conductive filler has a ratio of 6.0 or more as the ratio of the BET specific surface area to the equivalent sphere surface area based on D₅₀ of the conductive filler.

4. The conductive film according to claim 3, wherein the conductive filler is contained in an amount of 5% by mass or more and 15% by mass or less with respect to the total mass of the resin binder and the conductive filler.

5. A collector for a bipolar secondary battery, the collector comprising a conductive resin layer including
a conductive filler having a spike-shaped form or a structure-shaped form, and
a resin binder, wherein:
the conductive filler has a ratio of 5.0 or more and 10 or less as a ratio of a BET specific surface area to an equivalent sphere surface area based on D₅₀ of the conductive filler, and
the conductive filler is contained in an amount of more than 3.0% by mass and less than 20% by mass with respect to a total mass of the resin binder and the conductive filler.

6. The collector according to claim 5, wherein metal foil is laminated on the conductive resin layer.
